(19) United States
(12) Patent Application Publication
(10) Pub. No.: US 2024/0373782 A1
(43) Pub. Date: Nov. 14, 2024

(54) IMPROVED SCHEDULING FOR A ROBOTIC LAWNMOWER

(71) Applicant: HUSQVARNA AB, Huskvarna (SE)

(72) Inventors: Lars Roos, Ulricehamn (SE); Jonas Holgersson, Huskvarna (SE); Christer Thorn, Jonkoping (SE)

(21) Appl. No.: 18/691,138

(22) PCT Filed: Jun. 3, 2022
(86) PCT No.: PCT/SE2022/050543

§ 371 Date: Mar. 12, 2024

(30) Foreign Application Priority Data
Sep. 14, 2021 (SE) 2151128-2

(51) Int. Cl. A01D 34/00; A01D 101/00

(52) U.S. Cl. CPC A01D 34/008; A01D 2101/00

(57) ABSTRACT

A robotic work tool system comprising a robotic work tool configured to operate in a work area comprising a lawn being of at least one lawn type, the robotic work tool comprising a controller configured to operate in the work area based on a work schedule, wherein the work schedule includes an indication of a work amount, wherein the robotic work tool system is characterized in that the work amount is dependent on the lawn type.

### TECHNICAL FIELD

This application relates to robotic lawnmowers and in particular to a system and a method for providing an improved scheduling for a robotic lawnmower.

### BACKGROUND

Automated or robotic lawnmowers are becoming increasingly more popular. In a typical deployment a work area, such as a garden, the robotic lawnmower is commonly scheduled to operate at certain times and for certain lengths of time. The scheduling helps avoid the owners from being disturbed by the robotic lawnmower during operation while providing for a reasonably well-kept lawn.

The cutting and work scheduling for robotic lawnmowers ranges from date and time based scheduling, to automatic work area based scheduling, to more complicated, and even based on weather reports. If it rains, grass will be wet, which requires more time and/or power to cut the grass properly. Many prior art systems will account for weather variations and adapt the schedule accordingly. Some prior art systems may even adapt the scheduling based on the season so as to avoid operating in (heavy) snow thereby reducing the risk of the lawnmower getting stuck.

Remote controlled height adjustment of robotic lawn mowers is known feature which has been provided as a way to set the same cutting height for a complete work area, that is a piece of lawn. Even fancier usage where the robot could be giving a cutting path to follow while enforcing a certain cutting height at an area defined through coordinates. This has been presented as a way to imprint images, words and logotypes onto field of lawn.

However, as the inventors have realized after insightful reasoning and inventive thinking realizing an unknown problem, the prior art scheduling is incomplete in that it does not consider that different grasses or even areas in the same lawn may exhibit different grass characteristics, conditions and require optimal long-term lawn care and cutting operation for the well-being of the lawn itself.

Thus, there is a need for an improved manner of scheduling a robotic lawnmower and its parameters for a more optimal lawn care

### SUMMARY

As will be disclosed in detail in the detailed description, the inventors have realized that different work areas may have different lawn types and if so should not be scheduled in the same manner as the lawn type may require different handling.

It is therefore an object of the teachings of this application to overcome or at least reduce those problems by providing a robotic lawnmower system comprising a robotic work tool configured to operate in a work area comprising a lawn being of at least one lawn type, the robotic work tool comprising a controller configured to operate in the work area based on a work schedule, wherein the work schedule includes an indication of a work amount, wherein the robotic work tool system is characterized in that the work amount is dependent on the lawn type.

In some embodiments the work schedule includes an indication of a first time to operate and an indication of a second time to operate and wherein the time between the first time to operate and the second time to operate is dependent on the lawn type.

In some embodiments the work amount includes a time spent in an operation and wherein the time spent in an operation is based on the lawn type.

In some embodiments the work amount includes a navigational parameter wherein the navigational parameter depends on the lawn type.

In some embodiments the navigational parameter includes a length of traversal.

In some embodiments the navigational parameter includes number of passes.

In some embodiments the navigational parameter includes an operating pattern.

In some embodiments the work schedule is based on the time of year.

In some embodiments the work schedule is based on a weather forecast.

In some embodiments the robotic work tool comprises sensors and wherein the robotic work tool is configured to determine the weather based on input from the sensors.

In some embodiments the robotic work tool comprises a communication interface and wherein the robotic work tool is configured to determine the weather based on input through the sensors communication interface.

In some embodiments the work schedule determined by a server (240) and the robotic work tool is configured to receive the work schedule.

In some embodiments the robotic work tool is configured to determine the work schedule.

In some embodiments the lawn type is based on a grass type.

In some embodiments the lawn type is based on a quality of lawn.

In some embodiments the robotic work tool comprises sensors and wherein the robotic work tool is configured to determine the quality of lawn based on input from the sensors.

In some embodiments the robotic work tool is configured to determine the quality of lawn by forwarding the input from the sensors to a server.

In some embodiments the lawn type is based on an environmental factor.

In some embodiments the robotic work tool comprises sensors and wherein the robotic work tool is configured to determine the environmental factor based on input from the sensors.

In some embodiments the robotic work tool is configured to determine the environmental factor by forwarding the input from the sensors to a server.

In some embodiments the robotic work tool is configured to determine that the lawn comprises weeds and in response thereto adapt a cutting height of the robotic work tool by for a first time period increasing the cutting height from a default cutting height to a maximum cutting height and for a second time period setting the cutting height to the default cutting height.

In some embodiments the robotic work tool is a robotic lawnmower.

It is also an object of the teachings of this application to overcome the problems by providing a method for use in a robotic work tool system comprising a robotic work tool configured to operate in a work area comprising a lawn being of at least one lawn type, the method comprising: determining a lawn type; determining an operating schedule based on the lawn type; and operating based on the operating schedule.

In some embodiments the method further comprises determining that the lawn comprises weeds and in response thereto adapting a cutting height of the robotic work tool by for a first time period increasing the cutting height from a default cutting height to a maximum cutting height and for a second time period setting the cutting height to the default cutting height.

It is also an object of the teachings of this application to overcome the problems by providing a robotic work tool system comprising a robotic work tool configured to operate in a work area comprising a lawn, wherein the robotic work tool is configured to determine that the lawn comprises weeds and in response thereto adapt a cutting height of the robotic work tool by for a first time period increasing the cutting height from a default cutting height to a maximum cutting height and for a second time period setting the cutting height to the default cutting height.

It is also an object of the teachings of this application to overcome the problems by providing a method for use in a robotic work tool system comprising a robotic work tool configured to operate in a work area comprising a lawn, the method comprising determining that the lawn comprises weeds and in response thereto adapting a cutting height of the robotic work tool by for a first time period increasing the cutting height from a default cutting height to a maximum cutting height and for a second time period setting the cutting height to the default cutting height.

Other features and advantages of the disclosed embodiments will appear from the following detailed disclosure, from the attached dependent claims as well as from the drawings. Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention will be described in further detail under reference to the accompanying drawings in which:

FIG. 1A shows an example of a robotic lawnmower according to one embodiment of the teachings herein;

FIG. 1B shows a schematic view of the components of an example of a robotic lawnmower being a robotic lawnmower according to an example embodiment of the teachings herein;

FIG. 2 shows an example of a robotic lawnmower system being a robotic lawnmower system according to an example embodiment of the teachings herein;

FIG. 3A shows a schematic view of a robotic lawnmower system according to an example embodiment of the teachings herein;

FIG. 3B shows a corresponding flowchart for a method according to an example embodiment of the teachings herein; and

FIG. 4 shows a schematic view of a cutting scheme for a robotic lawnmower according to an example embodiment of the teachings to remedy lawn weed problems.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein. Like reference numbers refer to like elements throughout.

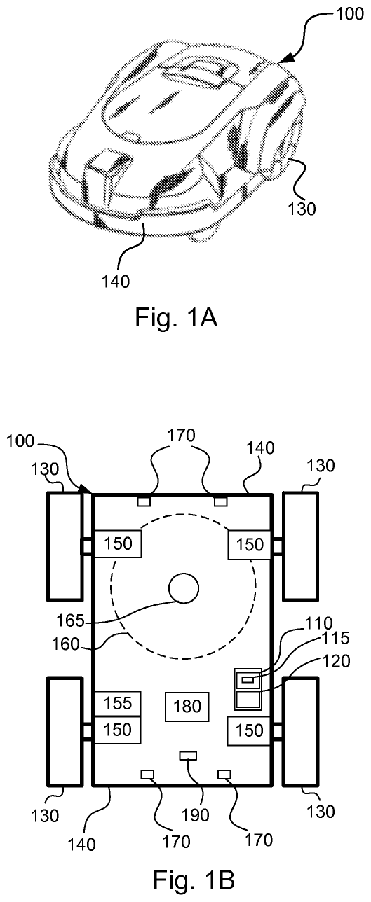

FIG. 1A shows a perspective view of a robotic lawnmower 100, here exemplified by a robotic lawnmower 100, having a body 140 and a plurality of wheels 130 (only one side is shown).

FIG. 1B shows a schematic overview of the robotic lawnmower 100, also exemplified here by a robotic lawnmower 100. In this example embodiment the robotic lawnmower 100 has a main body part 140 substantially housing all components of the robotic lawnmower 100. The robotic lawnmower 100 has a plurality of wheels 130. In the exemplary embodiment of FIG. 1B the robotic lawnmower 100 has four wheels 130, two front wheels and two rear wheels. At least some of the wheels 130 are drivably connected to at least one electric motor 150. It should be noted that even if the description herein is focused on electric motors, combustion engines may alternatively be used, possibly in combination with an electric motor.

The robotic lawnmower 100 also comprises a grass cutting device 160, such as a rotating blade 160 driven by a cutter motor 165. In some embodiments the grass cutting device 160 is arranged to enable adaption of the cutting height, the cutting speed and/or the cutting angle. The robotic lawnmower 100 also has (at least) one battery 155 for providing power to the motor(s) 150 and/or the cutter motor 165.

The robotic lawnmower 100 also comprises a controller 110 and a computer readable storage medium or memory 120. The controller 110 may be implemented using instructions that enable hardware functionality, for example, by using executable computer program instructions in a general-purpose or special-purpose processor that may be stored on the memory 120 to be executed by such a processor. The controller 110 is configured to read instructions from the memory 120 and execute these instructions to control the operation of the robotic lawnmower 100 including, but not being limited to, the propulsion of the robotic lawnmower. The controller 110 may be implemented using any suitable, available processor or Programmable Logic Circuit (PLC). The memory 120 may be implemented using any commonly known technology for computer-readable memories such as ROM, RAM, SRAM, DRAM, FLASH, DDR, SDRAM or some other memory technology.

The memory is configured to store an operating schedule which the controller is configured to control the robotic lawnmower to operate accordingly. The operating schedule may indicate when to operate, for how long to operate, where to operate (area and/or operating pattern) and/or a degree of operation. For the robotic lawnmower the degree of operation may be the cutting height, cutting disc speed and/or cutting angle. The operating schedule thus does not simply relate to a time when to operate and duration of time to operate, but also relates to time, duration, cutting height, cutting pattern, disc speed, etc to mention a few examples. It should be noted that even though the description herein is focussed on a robotic lawnmower cutting grass, the teachings herein may also apply to other robotic work tools arranged to operate on a lawn, such as robotic mulcher, watering robots, robotic raking machines, and/or any combination thereof. The robotic lawnmower is thus one, out of many examples of a robotic work tool arranged according to the teachings herein.

The memory is, in some embodiments, configured to store a data base of different types of lawn, and how they should best be operated in for different geographical areas and other environmental factors. The database may be generated based on machine learning or be an expert system. The database may be trained by a server by the controller or by some remote device, whereby the database is downloaded already (at least initially) trained. Even if a trained database is downloaded, the server and/or the controller may update or continue the training of the database based on continued operating, server data (or data retrieved by the server) and/or sensor input.

The memory may also be configured to store a map of the work area. The map may indicate boundaries, obstacles and different lawn types.

The robotic lawnmower 100 may further be arranged with a wireless communication interface 115 for communicating with other devices, such as a server, a personal computer or smartphone, the charging station, and/or other robotic lawnmowers. Examples of such wireless communication devices are Bluetooth®), WiFi®) (IEEE802.11b), Global System Mobile (GSM) and LTE (Long Term Evolution), to name a few.

The communication interface 115 may be utilized to receive updates on environmental factors (weather), data on different grass types, and updates to the operating schedule.

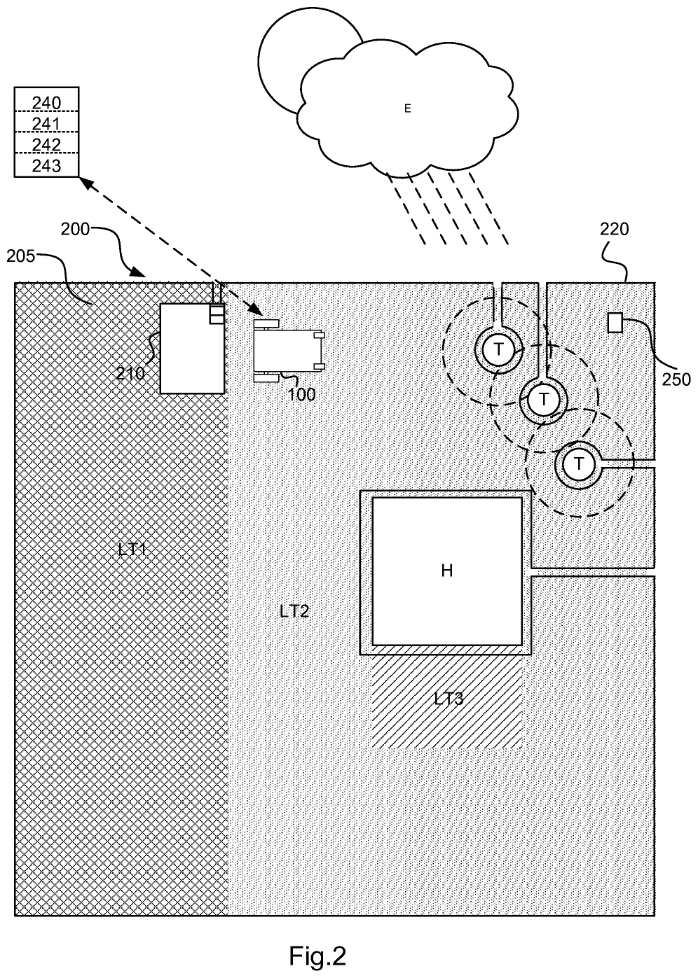

For enabling the robotic lawnmower 100 to navigate with reference to a boundary wire emitting a magnetic field caused by a control signal transmitted through the boundary wire, the robotic lawnmower 100 is further configured to have at least one magnetic field sensor 170 arranged to detect the magnetic field (not shown) and for detecting the boundary wire and/or for receiving (and possibly also sending) information to/from a signal generator (will be discussed with reference to FIG. 2).

In one embodiment, the robotic lawnmower 100 may further comprise at least one navigation sensor, such as a beacon navigation sensor and/or a satellite navigation sensor 190. The beacon navigation sensor may be a Radio Frequency receiver, such as an Ultra Wide Band (UWB) receiver or sensor, configured to receive signals from a Radio Frequency beacon, such as a UWB beacon. Alternatively or additionally, the beacon navigation sensor may be an optical receiver configured to receive signals from an optical beacon. The satellite navigation sensor may be a GPS (Global Positioning System) device or other Global Navigation Satellite System (GNSS) device.

In one embodiment the robotic lawnmower 100 comprise at least one Real-Time Kinematics (RTK) GNSS position tracking sensor.

In one embodiment the robotic lawnmower 100 comprises a Simultaneously Localization And Mapping (SLAM) based navigation system.

In one embodiment, the robotic lawnmower 100 comprises a camera sensor and an image processing unit for image capturing collaborating with a local or cloud based image recognition and classification service, for land area surface analysis and classification of surface, plants and objects, such as grass phenotypes.

In embodiments, where the robotic lawnmower 100 is arranged with a navigation sensor, the magnetic sensors 170 are optional.

The robotic lawnmower 100 also comprises environmental sensors 180. Such sensors 180 may be arranged to detect grass height (and thereby grass growth over time), soil quality, moisture, ambient light conditions (shade/sunlight), projecting and receiving reflected light (for example Infra-Red light), gas sensors, scent (electronic nose) sensor, remote weather data sources, and image recognition and classification sensors for grass, weed, phenotype and grass tip cutting quality recognition.

FIG. 2 shows a schematic view of a robotic lawnmower system 200 in one embodiment. The schematic view is not to scale. The robotic lawnmower system 200 comprises a robotic lawnmower 100. As noted above the robotic lawnmower is but one example of a robotic work tool. The robotic lawnmower system may comprise a combination of robotic work tools, one being a robotic lawnmower, but the teachings herein may also be applied to other robotic work tools adapted to operate within a work area 205.

The robotic lawnmower system 200 may also comprise charging station 210 which in some embodiments is arranged with a signal generator and a boundary wire 220. The signal generator is arranged to generate a control signal to be transmitted through the boundary wire 220. In such embodiments the work area is bounded by the boundary wire 220.

In some embodiments, where the robotic lawnmower 100 is configured to operate according to a satellite navigation sensor 190, the work area 205 is bounded by a virtual boundary. In such embodiments, a map of the work area 205 may be stored in the memory 120 of the robotic lawnmower 100.

The work area 205 is in this application exemplified as a garden but can also be other work areas as would be understood. The garden contains a number of obstacles (O), exemplified herein by a number (3) of trees (T) and a house structure (H). The trees are marked both with respect to their trunks (filled lines) and the extension of their foliage (dashed lines).

A server 240 may also be part of the robotic lawnmower system 200 or at least be arranged to be connected to the robotic lawnmower 100 through the communication interface 115. The server may be a cloud server or a service server. Alternatively, or additionally the server may be part of a personal computer or smartphone. The server comprises or is connected to a controller 241 for controlling the operating of the server, a memory for storing operating schedules and data on lawn types as well as image classification databases used to identify lawn types and/or grass types (including type of lawn, type of grass, condition as relates to quality, diseases, length, structure, moisture, or water content to mention a few example, for individual grass straws, plants, and/or clusters), and a communication interface for communicating with the robotic lawnmower 100, but also with other servers/services. The server 240 is thus available to provide information on for example weather as discussed in the above.

The garden of this example comprises areas with different lawn types. In the example of FIG. 2, there are three different lawn types, LT1, LT2 and LT3. In some embodiments a lawn type refers to a type of grass. In some embodiments a lawn type refers to a condition for a type of grass (in addition or as an alternative to other types discussed herein), such as that this area is experiencing special environmental factors or usage factors. Examples of environmental factors are that the area is shaded (and to what extent and when), the quality of the soil and/or kind of soil), or if the area is prone to flooding. Examples of usage factors are that the area is used often (being treaded upon, and to what extent) or that the area is part of a transport path (such as being driven upon).

In the example of FIG. 2 the first lawn type LT1 is in an area remote from the house, where the grass is of a rough (er) type (a first grass type). The second lawn type LT2 is in an area closer to the house, where the grass is of a fine (r) type (a second grass type). And the third lawn type LT3 is in a shaded area behind the house (a first environmental factor), and of the fine (r) type (the second grass type).

FIG. 2 also shows a cloud with rain and a sun for indicating external environmental factors referenced E. Such external environmental factors may be detected by sensors in the robotic lawnmower 100, or through communicating with a server application, as discussed in the above, for receiving weather information. FIG. 2 also shows external sensors 250 directly or indirectly connected with the robotic lawnmower to sense such environmental factors and communicate these to the robotic lawnmower. Examples of such sensors are moisture sensors, light sensors to mention a few examples. In some embodiments such environmental factors may be indicated through user input to the robotic lawnmower, directly or indirectly possibly through a server interface.

In order to operate the work area properly through all seasons and over time, the robotic lawnmower is configured to receive input regarding grass type for the work area, possibly for a subarea of the work area. The input regarding grass type may be received from grass type detecting sensors (such as a camera housed as part of the environmental sensors 180, whereby the grass type may be detected by the robotic lawnmower 100. Alternatively or additionally a user may provide input on the grass type, possibly directly to the robotic lawnmower 100 or through another device (such as the server 240) and then to the robotic lawnmower through the communications interface.

The robotic lawnmower 100 is configured to determine the environmental factors and the usage factors possibly utilizing the sensors 180, 190 and/or the server 240. Such factors may include but not be limited to Soil, Height of existing grass, Cutting resistance, Seeds and plants, Nutrition, energy, watering, Weed, disease, rodents and pest, GPS position, season, images, user data.

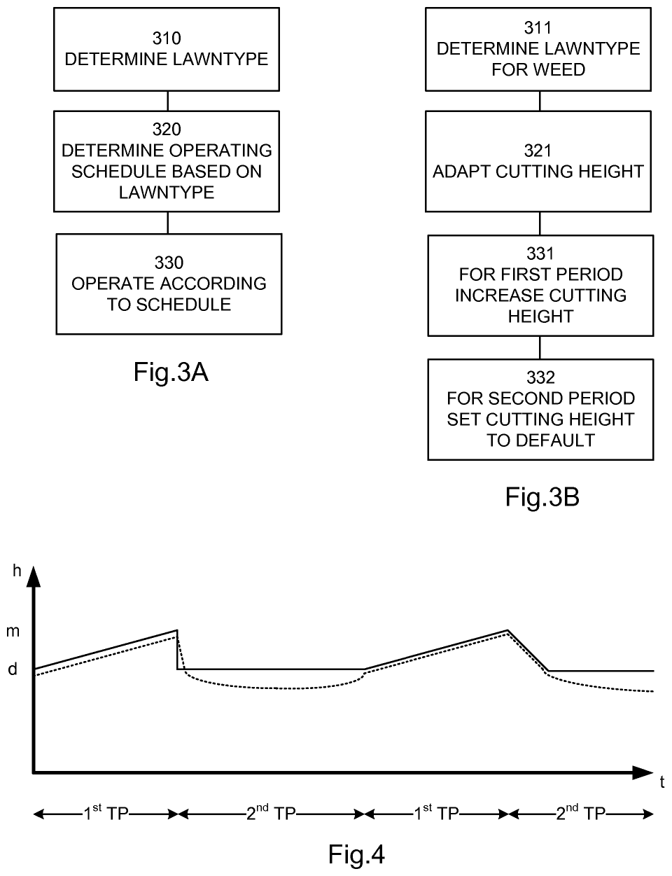

The operation of the robotic lawnmower 100 will be discussed herein with simultaneous reference to FIG. 2 and FIG. 3A, FIG. 3A showing a flowchart of a general method according to the teachings herein, as well as FIG. 3B for a general weed reduction method.

FIG. 2 thus shows a robotic lawnmower system comprising a robotic lawnmower configured to operate in a work area comprising a lawn being of at least one lawn type. The robotic lawnmower is configured to operate in the work area based on an operating schedule, wherein the operating schedule includes an indication of a work amount. To be noted is that the work amount is dependent on the lawn type.

The work amount indicates one or more of frequency of operation, duration of operation, time for operation, criteria for finishing working, work pattern, degree of operation (such as cutting height, cutting disc speed). The work amount may also or alternatively indicate one or more of energy usage, cutting frequency, length range, cutting even-ness, density, wear-ability of grass may be just a few parameters that may be considered for optimization using a combination of auto scheduling, height adjustment, RPM adjustment, knife adjustments, rotation-direction of knife as adjustment (e.g. a blade may be normally cutting in one direction, except where a better cutting result is expected where the lawnmower may us its exclusive saved sharpest edge for best effort cutting).

The dependency on the lawn type enables the robotic lawnmower 100 to operate differently in different lawn types, for example wherein one lawn type may be operated on more frequently or to a higher degree than another lawn type. Another example is that one lawn type is operated upon during different times of day and/or year. Another example is that one lawn type is operated upon in a different operating pattern. Of course, any combination of such factors is possible. The operating schedule may thus include an indication of a first time to operate and an indication of a second time to operate and wherein the time between the first time to operate and the second time to operate is dependent on the lawn type. The times to operate may thus also or alternatively be given in many different ways, by frequency, by specific times/dates and so on. The work amount may thus also or alternatively include a time spent in an operation and wherein the time spent in an operation is based on the lawn type.

To enable for different patterns to be performed, the work amount may include a navigational parameter wherein the navigational parameter depends on the lawn type. The navigational parameter includes a length of traversal, a number of passes and/or an operating pattern

As mentioned, the operating schedule may be based on the time of year (season) which enables the robotic lawnmower to operate differently over a year for different lawn types.

As also mentioned above, the operating schedule can also be based on the weather. The weather may be detected by being sensed by the sensors 180 and/or by receiving weather data from the server 240. This enables for the robotic lawnmower to operate differently based on the weather, wherein some weather may provide for different operating patterns (for example no/reduced operation when wet) for different grass types and/or lawn types. For example an area prone to flooding should not be operated (as frequently) in or after rain.

As discussed also above, the operating schedule is in some embodiments determined by the server 240 and received by the robotic lawnmower 100. In some such embodiments, the robotic lawnmower 100 is configured to provide operating data to the server 240, so that the server can base the operating schedule on the operating data.

Alternatively or additionally the operating schedule can be determined by an application in a user device and received by the robotic lawnmower, in a similar fashion as when the server determines the operating schedule. In some such embodiments, the server may be seen as implemented in a user device as an application (app).

Alternatively or additionally the operating schedule can be determined by the controller of the robotic lawnmower. In some such embodiments, the server (and/or app) is configured to provide the robotic lawnmower with environmental data for the operating schedule to be based on.

As also discussed in the above, the lawn type is based on a grass type, wherein a grass type may be pre-specified as a default grass type. The default grass type may be specific to a geographical regions representing the most commonly used grass type(s) in that region. Or the grass type may be determined based on sensor data (such as images of the grass) by the controller or by the server. The sensor data is matched against known sensor data for a grass type to find a matching grass type.

In some embodiments the grass type relates to a grass species.

In some embodiments the lawn type relates to a quality (or grade) of the lawn. In some embodiments the quality of the lawn relates to how worn or trodden the lawn is. The quality of the lawn may be determined by user input. Alternatively or additionally, the quality of the lawn is determined by the controller or the server automatically based on sensor input.

Such automatic determination of grass type and/or quality may be done through image classification based on deep learning algorithms. The images could be provided by a camera being housed as part of the sensors, by surveillance cameras for the work area and/or based on satellite images of the area.

Alternatively or additionally sub portions or segments (such as the third lawn type LT3), could also be detected or determined automatically through such image classification.

The robotic lawnmower is thus configured for determining 310 a lawn type; determining 320 an operating schedule based on the lawn type; and operating 330 based on the operating schedule.

The determination of lawn may be determined by user input. Alternatively or additionally, the determination of lawn is determined by the controller or the server automatically based on sensor input.

The determination of lawn type and/or the determination of how to determine (adapt or select) the operating schedule is in some embodiments performed utilizing a neural network, or other machine learning system, where the system is trained using determined lawn types, environmental factors, previously used operating schedules (or parameters thereof), and/or the resulting grass status (including quality and/or height), whereby the system is enabled to identify types of lawn types, environmental factors and be able to propose a fitting operating schedule resulting in a desired quality of lawn.

One particular lawn type will now be discussed with reference to FIGS. 3B and 4, namely a lawn type that includes or contains weeds. Through inventive reasoning and research, the inventors have realized that certain weeds adapt to the cutting height of a lawn, and will stop growing past a height under the cutting height, which enables the weed to spread over the lawn, the weed growing sideways.

In order to overcome this, the inventors are proposing a specific operating schedule for lawn types containing weed as will be shown in FIG. 3B showing a flowchart of a method according to the teachings herein and FIG. 4, showing an adapted cutting height of a robotic lawnmower according to the teachings herein. The operating schedule is based on an adaptation or change of the cutting height. As the lawn type is determined 310, it may be determined 311 that the lawn type contains weed and a lawn type for weed is thus determined or selected. In some embodiments, the robotic lawnmower is configured to also determine (autonomously or through input) the type of weed, and determine the lawn type accordingly.

Based on the lawn type being for weed, the operating schedule is adapted or determined 320 to adapt the cutting height 321. As the robotic lawnmower 100 operates 330 according to the operating schedule, the robotic lawnmower is configured to operate in a first time period and a second time period.

In the first time period the cutting height will be increased 331 successively from a default cutting height to a maximum cutting height. The maximum cutting height is, in some embodiments, the maximum cutting height of the robotic lawnmower 100. The maximum cutting height is, in some embodiments, a maximum cutting height for weed, and in some such embodiments, a maximum cutting height for an identified type of weed. The maximum cutting height is, in some embodiments, the default cutting height multiplied by 1.5 (for cutting one third of the grass height in the second time period). The maximum grass height (as well as or as an alternative to the minimum grass height) may be set depending on grass type. The increase may be on a daily basis, where the cutting height is increased every day. The increase may be for each operating session, where the cutting height is increased every operating session. The increase may be gradual, continuous or stepwise. In some embodiments, the first time period is 5, 10, 15, 20, 25 or 30 days. In some embodiments, the first time period is 1, 2, 3, or 4 weeks.

In some embodiments, the first time period is 1 or 2 months. In the second time period the cutting height will be the default cutting height. In some embodiments, the second time period is 5, 10, 15, 20, 25 or 30 days. In some embodiments, the second time period is 1, 2, 3, or 4 weeks. In some embodiments, the second time period is 1 or 2 months.

In some embodiments, the first time period and/or the second time period is determined by the robotic lawnmower 100, based on sensor input. The sensor input may relate to the growth of the weed, and the robotic lawnmower is thus enabled to-over time-determine what time periods provide the least growth of weed and adapt the time periods accordingly.

The effect of the adapted cutting height is that the grass will for a (first) time period be allowed to grow taller than usual. This will have two effects. Firstly, the taller grass will have a suffocating or choking effect on the weed. Grass will normally outgrow and compete stronger in growth than weeds. This will stunt the spread of weaker weeds. Secondly, the stronger weeds that can compete with grass in terms of growth will need to grow taller in order to keep up with the height of the grass. When the default cutting height is resumed, the grass and the taller weeds will be chopped. Grass is fine with being cut down as long as less than a third of the straw is cut. Weeds will however take more damage from being cut, which will stunt the spread of stronger weeds. In order to avoid tufts during the growth period (first period), the height should be ramped up progressively over a number of operating sessions.

In some embodiments the robotic lawnmower 100 is configured to return to the default cutting height in the second time period by decreasing the cutting height gradually, continuously or stepwise over a downramping number of operating sessions. This in order to avoid tufts during the down cutting for a robotic lawnmower with random cutting patterns.

In some embodiments, where the robotic lawnmower 100 has systematic cutting patterns (which are understood herein to be cutting patterns where the height of cutting is changed over time) can change to the default height immediately.

FIG. 4 illustrates the intended effects on grass and weed growth as per the change in cutting height in the two time periods. In FIG. 4, the cutting height (h) of the operating schedule is shown over time (t). As can be seen the robotic lawnmower increases the cutting height (shown by the full line) from the default cutting height (d) to the maximum cutting height (m) in the first time period (1^{st} TP). As the cutting height increases the weed will be allowed to grow taller (weed growth shown by the dotted line).

In the second time period (2^{nd} TP) the cutting height is (again) set to the default cutting height.

In some embodiments, the first and second time periods are repeated. In some such embodiments, the first and second time periods are repeated if it is determined that weed is still present.

Another or subsequent first time period (1^{st} TP) is also shown in FIG. 4, followed by another or subsequent second time period (2^{nd} TP). As can be seen in the subsequent second time period, the robotic lawnmower utilizes a downramping of the cutting height, which also indicates that different cutting patterns may be used in different time periods.

This has the benefit in that it leads to an improved perception of lawn quality while using existing mechanical and hardware solutions. This can be implemented in software and used on most existing and future robotic lawnmower products that are equipped with a motor for adjusting the cutting height.

It should be noted that the adapted cutting height based on weed may also be used in robotic lawnmowers that are set up or configured independently of the other teachings of this application. The teachings of adapting the cutting height to suppress weed height is thus an invention in itself and can be used independently. The robotic lawnmower may thus be configured to determine that the lawn comprises or contains weeds and in response thereto adapt the cutting height. The determination may be through specific user input indicating weed (such as through activating a weed suppressing command) or through sensor input as discussed in the above.

1. A robotic work tool system comprising a robotic work tool configured to operate in a work area comprising a lawn being of at least one lawn type, the robotic work tool comprising a controller configured to operate in the work area based on a work schedule, wherein the work schedule includes an indication of a work amount, wherein the robotic work tool system is characterized in that the work amount is dependent on the lawn type, wherein the work amount includes a navigational parameter wherein the navigational parameter depends on the lawn type and wherein the navigational parameter includes an operating pattern.

2. The robotic work tool system of claim 1, wherein the work schedule includes an indication of a first time to operate and an indication of a second time to operate and wherein the time between the first time to operate and the second time to operate is dependent on the lawn type.

3. The robotic work tool system of claim 1, wherein the work amount includes a time spent in an operation and wherein the time spent in an operation is based on the lawn type.

4. (canceled)

5. The robotic work tool system of claim 1, wherein the navigational parameter includes a length of traversal.

6. The robotic work tool system of claim 1, wherein the navigational parameter includes number of passes.

7. (canceled)

8. The robotic work tool system of claim 1, wherein the work schedule is based on the time of year.

9. The robotic work tool system of claim 1, wherein the work schedule is based on a weather forecast.

10. The robotic work tool system of claim 9, wherein the robotic work tool comprises sensors and wherein the robotic work tool is configured to determine the weather based on input from the sensors.

11. The robotic work tool system of claim 9, wherein the robotic work tool comprises a communication interface and wherein the robotic work tool is configured to determine the weather based on input through the sensors communication interface.

12. (canceled)

13. (canceled)

14. The robotic work tool system of claim 1, wherein the lawn type is based on a grass type.

15. The robotic work tool system of claim 1, wherein the lawn type is based on a quality of lawn.

16. (canceled)

17. (canceled)

18. The robotic work tool system of claim 1, wherein the lawn type is based on an environmental factor.

19-21. (canceled)

22. The robotic work tool system (200) according to claim 1, wherein the robotic work tool is a robotic lawnmower.

23. A method for use in a robotic work tool system comprising a robotic work tool configured to operate in a work area comprising a lawn being of at least one lawn type, the method comprising:
determining a lawn type;
determining an operating schedule based on the lawn type; and
operating based on the operating schedule, wherein the work schedule includes an indication of a work amount, wherein the method is characterized in that the work amount is dependent on the lawn type, wherein the work amount includes a navigational parameter wherein the navigational parameter depends on the lawn type and wherein the navigational parameter includes an operating pattern.

24-26. (canceled)
